(19) United States
(12) Patent Application Publication
(10) Pub. No.: US 2012/0249851 A1
(43) Pub. Date: Oct. 4, 2012

(54) ECLIPSE DETECTION USING DOUBLE RESET SAMPLING FOR COLUMN PARALLEL ADC

(75) Inventor: TORE MARTINUSSEN, Strommen (NO)

(73) Assignee: APTINA IMAGING CORPORATION, Georgetown Grand Cayman, KY (US)

(21) Appl. No.: 13/096,334

(22) Filed: Apr. 28, 2011

Related U.S. Application Data
(60) Provisional application No. 61/468,219, filed on Mar. 28, 2011.

(51) Int. Cl. H04N 5/335

(52) U.S. Cl. 348/308; 348/E05.091

(57) ABSTRACT

An imager includes a column line connected to a pixel array for providing a pixel output signal. The pixel output signal is sampled during reset and readout phases. An analog-to-digital converter (ADC), which is coupled to the column line, samples the pixel output signal and provides a digital output signal. The ADC is configured to sample the pixel output signal twice, during the reset phase, in order to detect eclipse in the pixel output signal. The ADC includes a comparator, sequentially operated by a reset control, for comparing a first pixel output voltage and a second pixel output voltage, respectively, during the reset phase. The comparator is configured to provide an output bit indicating detection of an eclipse, based on a difference between the first and second pixel output voltages.

### CROSS REFERENCE TO RELATED APPLICATIONS

This application claims priority of U.S. Provisional Patent Application Ser. 61/468,219, filed Mar. 25, 2011.

### FIELD OF THE INVENTION

The present invention relates generally to semiconductor imagers. More specifically, the present invention relates to an anti-eclipse (AE) circuit for imagers.

### BACKGROUND OF THE INVENTION

A CMOS imager circuit includes a focal plane array of pixel cells, each one of the cells including a photosensor, for example, a photogate, a photoconductor or a photodiode for accumulating photo-generated charge in a specified portion of a substrate. Each pixel cell has a charge storage region, formed on or in the substrate, which is connected to the gate of an output transistor that is part of a readout circuit. The charge storage region may be constructed as a floating diffusion (FD) region. In some imager circuits, each pixel may include at least one electronic device such as a transistor for transferring charge from the photosensor to the storage region and one device, also typically a transistor, for resetting the storage region to a predetermined charge level prior to charge transference.

In a CMOS imager, the active elements of a pixel cell perform the functions of: (1) photon to charge conversion; (2) accumulation of image charge; (3) resetting the storage region to a known state; (4) transfer of charge to the storage region; (5) selection of a pixel for readout; and (6) output and amplification of a signal representing the charge at the storage region. Photo-charge may be amplified when it moves from the initial charge accumulation region to the storage region. The charge at the storage region is typically converted to a pixel output voltage by a source follower output transistor.

FIG. 1 is an illustration of a conventional four transistor (4T) pixel 100 and an associated load circuit 120 (shown as a current source). The pixel 100 includes a light sensitive element 101, shown as a photodiode, a floating diffusion region C, and four transistors, namely, a transfer transistor 111, a reset transistor 112, a source follower transistor 113, and a row select transistor 114. The pixel 100 accepts a TX control signal for controlling the conductivity of the transfer transistor 111, a RS control signal for controlling the conductivity of the reset transistor 112, and a SEL control signal for controlling the conductivity of the row select transistor 114. The charge at the floating diffusion region C controls the conductivity of the source follower transistor 113. The output of the source follow transistor 113 is presented to load circuit 120 through the row select transistor 114, in which the latter outputs a pixel signal at node B, when the row select transistor 114 is conducting (i.e., when SEL is asserted).

The states of the transfer and reset transistors 111, 112 determine whether the floating diffusion region C is coupled to the light sensitive element 101 for receiving photo generated charge generated by the light sensitive element 101 during a charge integration period, or a source of pixel power VAA from node A during a reset period.

The pixel 100 is operated as follows: The SEL control signal is asserted to cause the row select transistor 114 to conduct. At the same time, the RS control signal is asserted while the TX control signal is not asserted. This couples the floating diffusion region C to the pixel power VAA at node A, and resets the voltage at node C to the an initial voltage. The pixel 100 outputs a reset signal VRST to the load circuit 120. Node B is coupled between the row select transistor 114 and the load circuit 120 and serves as an input to a sample and hold circuit (not shown) that samples and holds the pixel reset voltage VRST.

After the reset signal VRST has been output, the RS control signal is de-asserted. The light sensitive element 101 has been exposed to incident light and accumulates charge on the level of the incident light during a charge integration period. After the charge integration period and the output of the signal VRST, the TX control signal is asserted. This couples the floating diffusion region C to the light sensitive element 101. Charge flows through the transfer transistor 111 and diminishes the voltage at the floating diffusion region C. The pixel 100 outputs a photo signal VSIG to the load circuit 120 which appears at node B and is sampled by the sample and hold circuit (not shown). The reset and photo signals VRST, VSIG, are different components of the overall pixel output (i.e., Voutput=VRST−VSIG).

A pixel 100 is susceptible to a type of distortion known as eclipsing. Eclipsing refers to distortion arising when a pixel outputs a signal corresponding to a dark pixel even though bright light is incident upon the pixel. Eclipsing can occur when a pixel is exposed to bright light, as the light sensitive element 101 can produce a large quantity of photogenerated charge. While the pixel 100 is outputting the reset signal VRST, a portion of the photogenerated charge produced by the light sensitive element 101 during an ongoing integration period may spill over the transfer transistor 111 into the floating diffusion node C. This diminishes the reset voltage at the floating diffusion node and can cause pixel 100 to output an incorrect (i.e., diminished voltage) reset signal VRST. This, in turn, can cause the reset and photo signals VRST, VSIG, to be nearly the same voltage. For example, the photo and reset signals VRST, VSIG, may each be approximately 0 volts. The pixel output (VRST−VSIG) can, therefore, become approximately 0 volts, which corresponds to an output voltage normally associated with a dark pixel.

An anti-eclipse circuit can be used to minimize the effect of eclipsing. For example, since during eclipse a pixel's reset voltage tends to drop towards zero volts, an anti-eclipse circuit can monitor the voltage level of the reset signal. If the voltage level drops below a threshold voltage, the anti-eclipse circuit can assume that the eclipsing may occur (or is occurring) and then correct the voltage level of the reset signal by pulling the reset level up to a correction voltage, thereby minimizing the eclipsing effect.

U.S. Pat. No. 6,873,363, which issued on Mar. 29, 2005, describes flagging oversaturated pixels in an active pixel sensor (APS). This patent is incorporated herein by reference in its entirety. Various portions of the patent are described below:

As described therein, a saturation flag can be used to identify oversaturated pixels and replace the value read out from an oversaturated pixel with a predetermined maximum value corresponding to a maximum brightness for the pixel in the image. This removes the artifacts in the resulting image, and the pixels in the APS array that receive the most light appear brightest in the images that are produced.

FIG. 2 illustrates responses of a signal voltage S, a reset voltage R, and a difference voltage (R−S) to an incident light level. Region I represents the normal operating range of a pixel. At a zero incident light level 200, a pixel in the resultant image is black. At a high incident light level 202, a pixel in the resultant image has a brightest value.

At high incident light level 202, a photodiode becomes unable to absorb additional photons during the integration period and saturates. According to the description in the referenced patent, a saturation flag is set if the photodiode is saturated.

As shown in FIG. 2, Vadj is set slightly above Vsat. If signal voltage S is greater than Vadj, a comparator is used to provide an output which is LOW. Signal voltage S will be less than Vadj for all light levels exceeding an incident light level 204 in Region I of FIG. 2. If signal voltage S is less than Vadj, the comparator output is HIGH, which represents setting of a saturation flag.

Thus, each of the signals read out from pixels receiving incident light levels greater than incident light level 204 in Region I is replaced with a maximum digital value. Accordingly, the corresponding pixels in the image are the brightest.

At zero incident light level 200, signal voltage S equals reset voltage R. Consequently the difference voltage (R−S) equals zero. The sensor reads a zero value as indicating that the pixel has received no incident light. A zero value produces a black pixel in the resultant image. In Region I, signal voltage S is strongly responsive to the incident light level. As the light level increases, signal voltage S decreases while reset voltage R remains relatively constant. Thus, the difference voltage (R−S) increases, causing the pixel to brighten. Region I corresponds to a photodetector's active region.

Ideally, reset voltage R is constant. However, as shown in Region II of FIG. 2, reset voltage R drops gradually in response to increasing light levels. This effect is due to the pixel still being exposed to light and hence producing electron-hole pairs during the reset stage. Since there is a finite time between setting the photodiode to the reset value and sampling the reset value, electrons generated in the photodiode by photons during the reset stage can migrate and reduce the voltage on the positive terminal of photodiode 101.

In Region II, reset voltage R gradually drops while signal voltage S remains constant at Vsat. Consequently, the difference voltage (R−S) continues to drop with increasing light levels. In a conventional CMOS imager, the increasingly oversaturated pixel, which should appear to brighten in the image, actually reads out as a darkening pixel.

As shown in Region III, at an extremely high light level 206, reset voltage R will also saturate at Vsat and the difference voltage (R−S) will equal zero, representing a black pixel. Regions of such oversaturated pixels produce artifacts in conventional CMOS imagers.

Continuing description of the referenced patent, pixels exposed to light levels above light level 204 in Region I of FIG. 2 are flagged with an associated saturation flag and the digital value output for such pixels is replaced with a maximum digital value, e.g., 255 in an 8-bit sensor, thereby preventing artifacts from being produced in the image.

It will be appreciated that this anti-eclipse (AE) scheme is based on clamping the pixout voltage so that it does not drop below a certain level during reset sampling. The AE voltage setting, however, has to be high enough so that the signal chain saturates for brightly lit pixels, but not so high that it interferes with the pixel reset level when the pixel is not eclipsing.

If a pixel is brightly lit, charge accumulated in the floating diffusion (FD) between the reset pulse and reset sampling (SHR) can lower the sampled reset level. If the reset level drops sufficiently before it is sampled, the pixel output will not have sufficient swing left to saturate the ADC, when the signal is sampled after the transfer (TX). Eclipse occurs as dark areas in strongly saturated images (e.g. the center of the sun) become grey or black.

If the AE setting is too high, the AE clamp will affect the reset sampling even when the pixel is not in saturation, thereby destroying the double correlated sampling (CDS). Due to transistor threshold variation between clamping devices, some turn on too soon, causing column fixed pattern noise (FPN) in the image.

If the AE setting is too low, the signal chain does not saturate, and brightly lit areas become grey (weak eclipse). Due to threshold variation in AE clamp circuits, the grey areas will have stripes.

Unfortunately, with a lower reset level (as seen in high conversion gain pixels and soft FD reset (IR) pixels), there is less and less room for setting the AE voltage so that it does not destroy CDS while still saturating the signal chain. The present invention, as will be explained, uses the ADCs to detect eclipse, while avoiding the high clamping levels.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a conventional pixel and an associated load circuit.

FIG. 2 is a chart showing the pixel response as voltage levels versus incident light levels, for three different regions of pixel operation.

FIG. 3 is a block diagram of an imager.

FIG. 4 a block diagram of the imager of FIG. 3 communicating with other devices by way of a bus.

FIG. 5 is a block diagram of an optional amplifier and a successive approximation register (SAR) analog-to-digital converter (ADC) connected to a column line in an array of pixels in the imager of FIG. 3.

FIG. 6A is a block diagram of portions of the imager of FIG. 3, including various control signals provided to two column lines in the array, in accordance with an embodiment of the present invention.

FIG. 6B is a block diagram of a SAR ADC coupled to a column line in the array of the imager of FIG. 3, in accordance with an embodiment of the present invention.

FIGS. 7-10 are timing diagrams of pixel operations, during reset and readout phases, including eclipse detection (FIGS. 7-9) and clamping operation (FIG. 10), in accordance with different embodiments of the present invention.

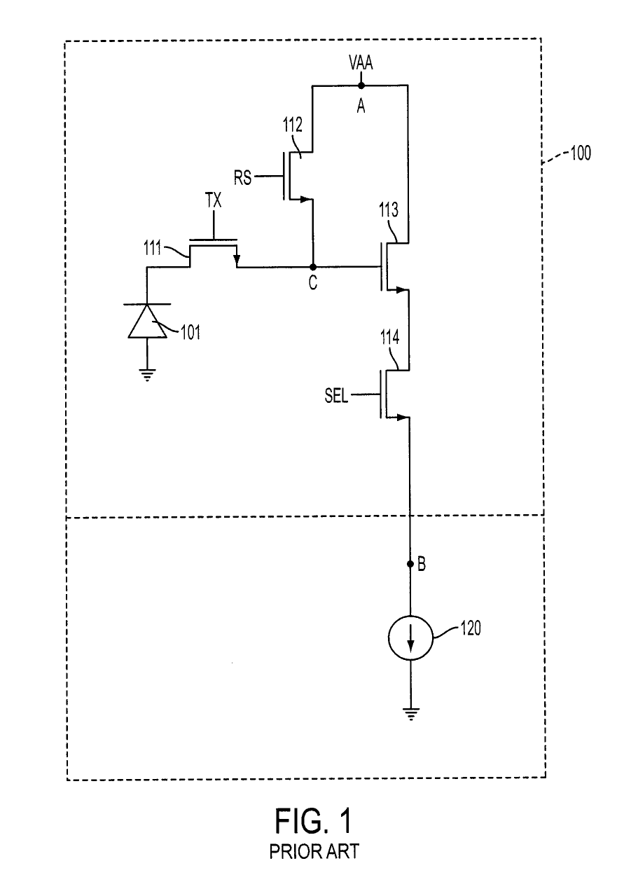

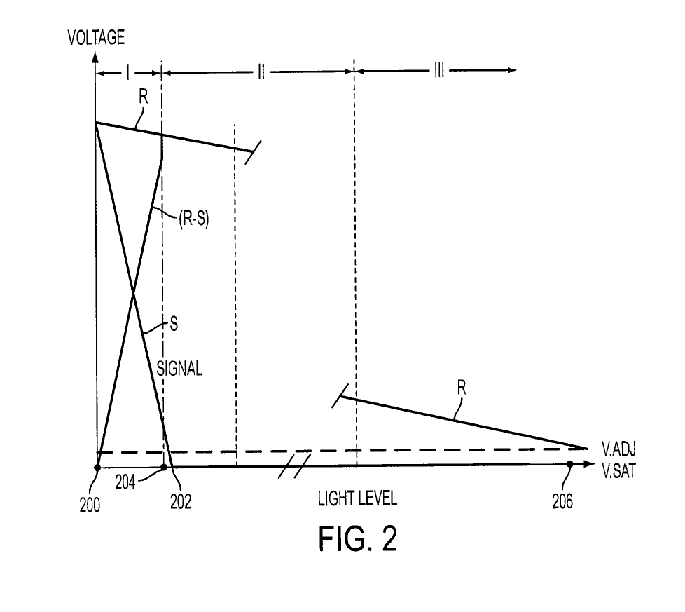

### DETAILED DESCRIPTION OF THE INVENTION

In the following detailed description, reference is made to the accompanying drawings, which form a part hereof and show by way of illustration specific embodiments in which the invention may be practiced. These embodiments are described in sufficient detail to enable those skilled in the art to practice the invention, and it is to be understood that other embodiments may be utilized, and that structural, logical, and electrical changes may be made without departing from the spirit and scope of the present invention. The progression of processing steps described is exemplary of embodiments of the invention; however, the sequence of steps is not limited to that set forth herein and may be changed as is known in the art, with the exception of steps necessarily occurring in a certain order.

The term “pixel,” as used herein, refers to a photo-element unit cell containing a photosensor and associated transistors for converting photons to an electrical signal. For purposes of illustration, a small number of representative pixels are illustrated in the figures and description herein: however, typically fabrication of a large plurality of like pixels proceeds simultaneously. Accordingly, the following detailed description is not to be taken in a limiting sense; and the scope of the present invention is defined only by the appended claims.

In addition, although the invention is described below with reference to a CMOS imager, the invention has applicability to any solid state imaging device having a storage node which is reset and then has charges transferred to it. The following detailed description is, therefore, not to be taken in a limiting sense, and the scope of the present invention is defined only by the appended claims.

Eclipse occurs when a pixel is so brightly lit that the floating diffusion (FD) is discharged significantly between the release of a reset (RST) pulse and the end of sampling. Due to the resulting drop in the pixel output (pixout) voltage towards the end of reset sampling (SHR), the difference between sampled voltages at SHR and signal sampling (SHS) is not enough to saturate the ADC, and pixels which should be read out as white become grey, or black.

As will be explained, the present invention uses one ADC clock cycle to compare the pixout voltage after reset A/D conversion, but before transfer (TX) to a digital threshold. In this manner, the present invention senses whether the pixel reset level is changing due to an eclipse condition (over-saturated photodetector blooming into the FD). This removes the need to saturate the signal chain during eclipse and allows a lowering of the pixout clamp voltage to a safe level. The decision from the extra ADC clock cycle is read out to the digital section to determine whether a pixel is eclipsing or not.

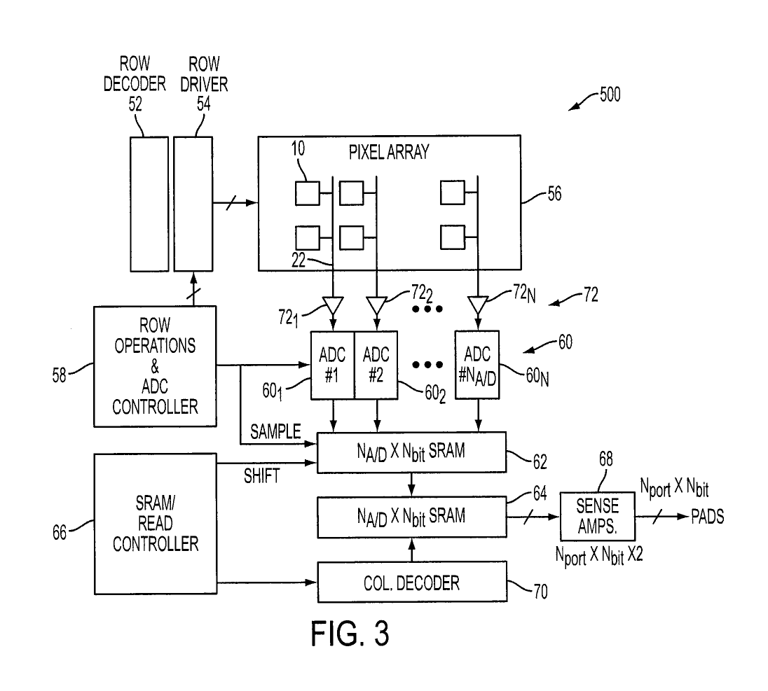

Now referring to the figures, where like numerals designate like elements, FIG. 3 shows a CMOS imager 500 comprising a pixel array 56 containing multiple pixels 10 organized into a plurality of rows and columns. The device 500 also contains a row decoder 52, row driver 54, row operations and ADC (analog-to-digital converter) controller 58, a plurality of analog-to-digital converters 60₁, 60₂, . . . , 60ₙ (collectively analog-to-digital converters 60), a static random access memory (SRAM)/read controller 66, a plurality of sample and hold (S/H) and amplifier circuits 72₁, 72₂, . . . , 72ₙ (collectively S/H circuits 72), two memory banks 62, 64, sense amplifier circuitry 68 and a column decoder 70.

The S/H circuits 72 are connected to the column lines 22 of the array 56. The analog-to-digital converters 60 are connected to the S/H circuits 72 by what is commonly known as a column-parallel architecture. That is, in the illustrated imaging device 500, each column or column line 22 of the array 56 is connected to a respective analog-to-digital converter 60, which operate in parallel to convert analog signals from the array 56 (via the S/H circuitry 72) to digital signals.

The imaging device 500 is operated by the row operations and ADC controller 58, which controls the row driver 54 and the analog-to-digital converters 60. The row operations and ADC controller 58 also issues a sample control signal SAMPLE to the first memory bank 62, which is illustratively an SRAM device. The second controller, i.e., the SRAM/read controller 66 also controls the operation of the imaging device 50 by controlling the second memory bank 64, also an SRAM device (via a shift control signal SHIFT), and the column decoder 70.

In operation, row lines are selectively activated by the row driver 54 in response to the row decoder 52. The S/H circuits 72 input a pixel reset signal Vrst and a pixel image signal Vsig for selected pixels. A differential signal is produced, by a differential amplifier within the S/H circuits 72, for each pixel and is digitize d by the analog-to-digital converters 60. The digitizing of the data from each column is performed in parallel. The digitized signals are stored in the first memory bank 62 (when the sample control signal SAMPLE is issued) and subsequently shifted into the second memory bank 64. the sense amplifier circuitry 68 senses the stored digital data from the second memory bank 64 and outputs the digital information so that it may be processed by e.g., an image processor (not shown).

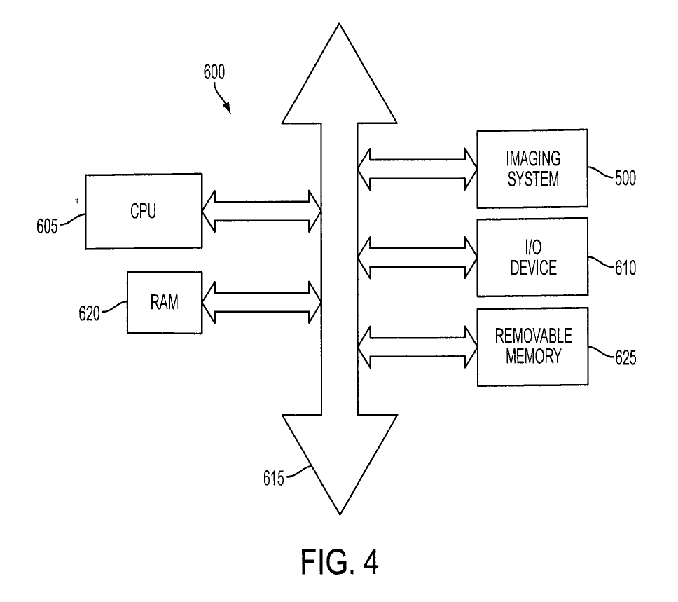

FIG. 4 illustrates a processor-based system 600, for example a camera system, which generally includes a central processing unit (CPU) 605, such as a microprocessor, that communicates with an input/output (I/O) device 610 over a bus 615. The system 600 also includes an imaging device 500 constructed in accordance with any of the embodiments of the invention. Imager 500 also communicates with the CPU 605 over bus 615. The processor-based system 600 also includes random access memory (RAM) 620, and can include removable memory 625, such as a flash memory, which also communicates with CPU 605 over bus 615. Imager 500 may be combined with a processor, such as a CPU, digital signal processor, or microprocessor, with or without memory storage on a single integrated circuit or on a different chip than the processor.

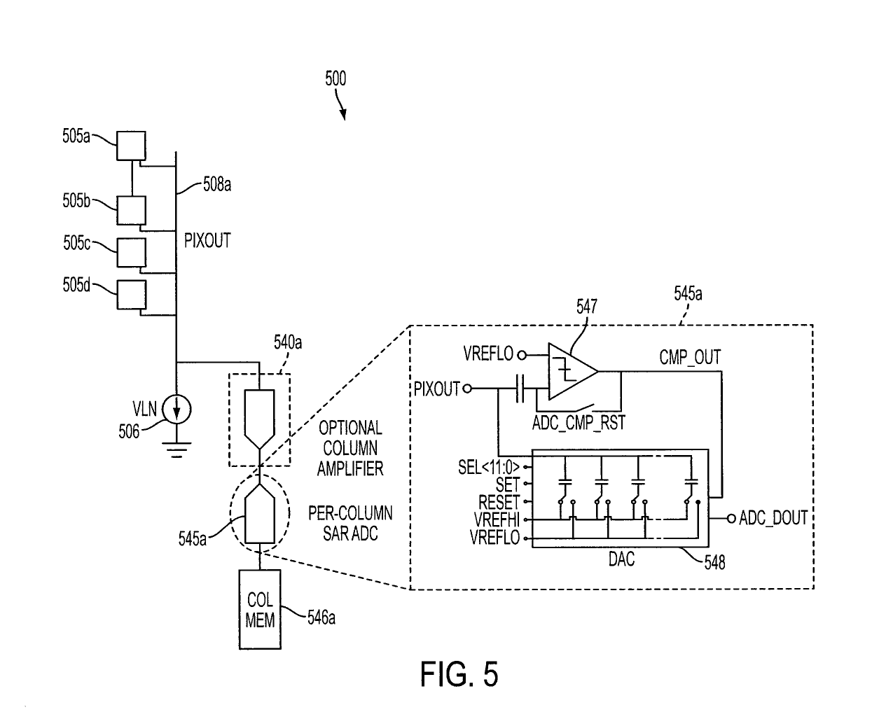

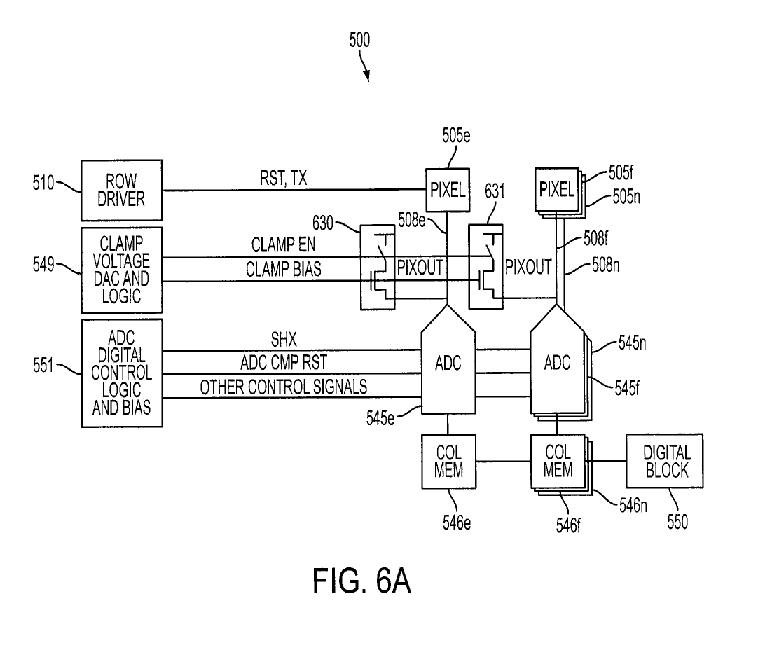

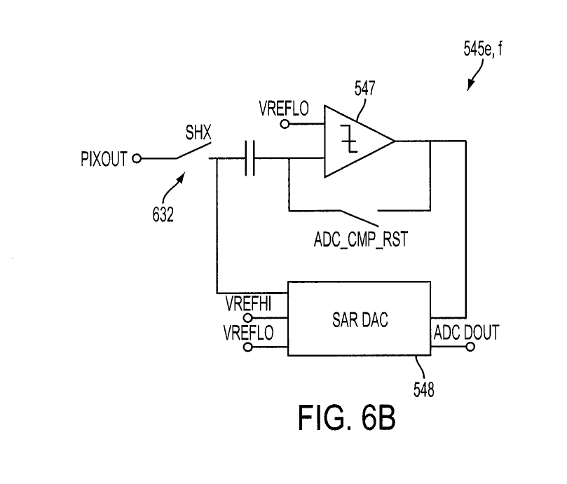

Turning next to FIGS. 5 and 6, there is shown a column topology of CMOS imager 500. As shown, the topology includes different row pixels 505a, 505b, 505c, 505d, etc., connected to column 508a, the latter providing the pixel output signal. The bottom of column 508a includes a load transistor, VLN, shown as current mirror 506.

The pixel output signal from column 508a is connected to column amplifier 540a, successive approximation register (SAR), analog-to-digital converter (ADC) 545a and column memory register 546a. The SAR ADC includes comparator 547 which provides an output (cmp_out) to a SAR digital-to-analog (DAC), the latter generally designated as 548. The DAC 548 runs a sequence based on the comparator output. It will be appreciated that the DAC is a parallel DAC and runs one cycle per bit to obtain a final digital output signal, adc_dout.

The Vrefhi and Vreflo are the upper and lower reference voltages (towards which the ADC compares an incoming pixel value). The difference between them indicates the full-scale input range of the ADC.

The sel<11:0> in the example shown in FIG. 5 is a bus used to select (address) specific latches in DAC 548. The <11:0> represents twelve bits. Each capacitor in the DAC may be switched between a high or low reference voltage, namely Vrefhi or Vreflo.

The set and reset controls are used to pre-set bits in the DAC to known values. Typically, before conversion begins, (a) the ADC comparator (which may be seen as a high-gain OTA in an open loop) is reset to remove any inherent offset and (b) the DAC is reset to a known value. The former ((a)) is done when adc_cmp_rst signal is asserted, which shorts inputs and outputs of the comparator during the beginning of signal sampling, and releases them before ADC conversion begins. The latter ((b)) is done by setting all the sel<11:0> signals, in order to address the whole DAC while applying the reset signal. This connects all the DAC capacitors to the Vreflo (as an example).

Cycling through the DAC bit by bit, starting with the MSB, the capacitors are connected to Vrefhi, one by one and, depending on the following comparator output, either moved back to Vreflo or left at Vrefhi. A capacitor is connected to Vrefhi by asserting both the sel signal and the set signal. After the comparator has completed a comparison, the result is written to the DAC's control latch for the bit, selecting to which voltage the DAC capacitor should be connected. At this point, the respective sel signal is still high. In addition, the sel<11:0> bus can be used to intentionally reset or re-write a particular bit by selecting the bit's address and the set or reset signal. This feature can be used to pre-program a threshold into the DAC for detecting eclipse.

It will be understood that the ADC described in FIG. 5 is a SAR ADC, but the present invention in not limited to only such an ADC. For example, cyclic ADCs and ramp ADCs may also be used.

Turning next to FIG. 6A, there is shown a portion of CMOS imager 500 including row driver 510, which drives, for example, pixel circuits 505e, 505f, etc., through 505n. Multiple columns are shown, namely columns 508e, 508f, etc., through 508n, respectively, attached to pixel circuits 505e-505n. The column 508e includes ADC 545e (may be a SAR ADC) and column memory 546e. Similarly, column 508f includes ADC 545f (may be a SAR ADC) and column memory 546f. Furthermore, column 508n includes ADC 545n (may be a SAR ADC) and column memory 546n. The column memories are connected to digital block 550.

It will be understood that column amplifiers are not required and may be omitted from each of the columns 508e and 508f, as shown in FIG. 6A. It will be appreciated that column 508a, however, includes column amplifier 540a, as shown in FIG. 5.

Still referring to FIG. 6A, RST and TX are pixel control signals, both generated by row driver 510. Next, the CLAMP_EN enables clamping of each of the pixel output lines. The CLAMP_BIAS is a control voltage supplied to an NMOS source follower circuit that prevents the pixout signal from dropping below a certain voltage on each of the column lines. The clamp level is determined by the clamp bias voltage, which is supplied by the clamp voltage DAC & logic circuit, designated as 549. The NMOS source follower circuits are, for example, circuit 630 operating on the pixout signal on column 508e, and circuit 631 operating on the pixout signal on column 508f.

The ADC's digital control logic & bias, generally designated as 551 in FIG. 6A, provides the SHX, the ADC_CMP_RST, and other control signals to each of the respective ADCs in columns 508e and 508f.

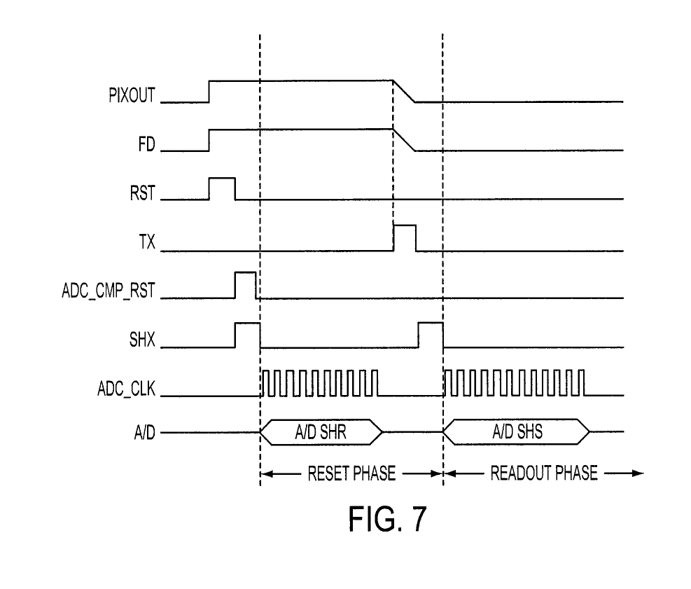

The SHX controls sampling switch 632, as shown in FIG. 6B. The switch 632 is closed during reset sampling and during signal sampling (shown in detail in FIGS. 7-10).

The ADC_CMP_RST signal resets the ADC's comparator 547, as shown in FIGS. 5 and 6B. At the beginning of an ADC conversion, the ADC's comparator is reset while sampling the reset signal (SHX is closed, but the ADC_CMP_RST switch opens before the reset sampling ends). By doing so, the ADC's zero level (the comparator's flipping point) is set close to the sampled reset level. This is described in detail with respect to FIGS. 7-10.

It will be understood that FIG. 6A is simplified and does not include a current source, which is shown as VLN 506 in FIG. 5. It also does not include a column amplifier 540, as shown in FIG. 5. If a column amplifier is added to FIG. 6A, then the clamp circuits 630 and 631 should be moved from the pixout lines to the outputs of the column amplifiers, respectively. This avoids amplifying the clamping levels.

The reset sampling (SHR) phase and the signal sampling (SHS) phase will now be described, including an anti-eclipse sampling (AE) phase, with reference to the timing diagrams shown in FIGS. 7-10. Each of the figures shows the same signals. Thus, FIGS. 7-10 show (in sequence from the top of the page to the bottom of the page) the following signals (each signal has been described earlier):

(1) PIXOUT (pixel output);

(2) FD (floating diffusion signal);

(3) RST (reset control);

(4) TX (transfer control);

(5) ADC_CMP_RST (ADC comparator reset control);

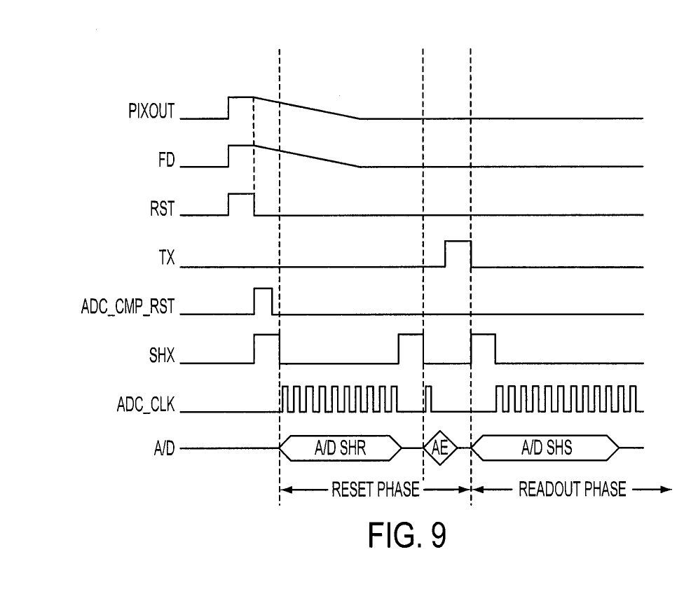

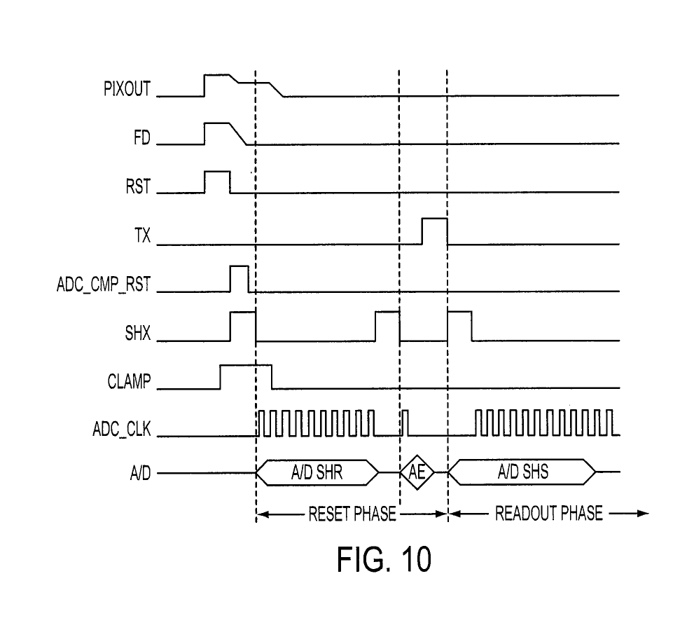

(6) SHX (reset sampling control, signal sampling control, and AE sampling control (the latter shown in FIGS. 9 and 10));

(7) ADC_CLK (clocking signal controlling timing of the ADC);

(8) A/D (converted reset signal SHR), converted signal (SHS), and converted AE signal (shown in FIGS. 9 and 10)); and

(9) clamp control, shown in FIG. 10 only, for enabling clamping of the pixout signal on a column line.

Referring first to FIG. 7, there is shown the timing relationship for a conventional CMOS imaging sensor with digital CDS (DCDS) and without anti-eclipse. As shown, the ADC's comparator 547 is reset (using the ADC_AMP_RST) before starting sampling of the reset signal (SHR). This cancels any offset in the ADC and sets the reset level as the ADC's new zero level for converting both the reset signal (SHR) and the pixel's intensity signal (SHS).

It will be understood that FIG. 7 shows a normal (non-eclipse) situation in which the pixel signal does not drop between the falling edge of the RST control and the rising edge of the TX control.

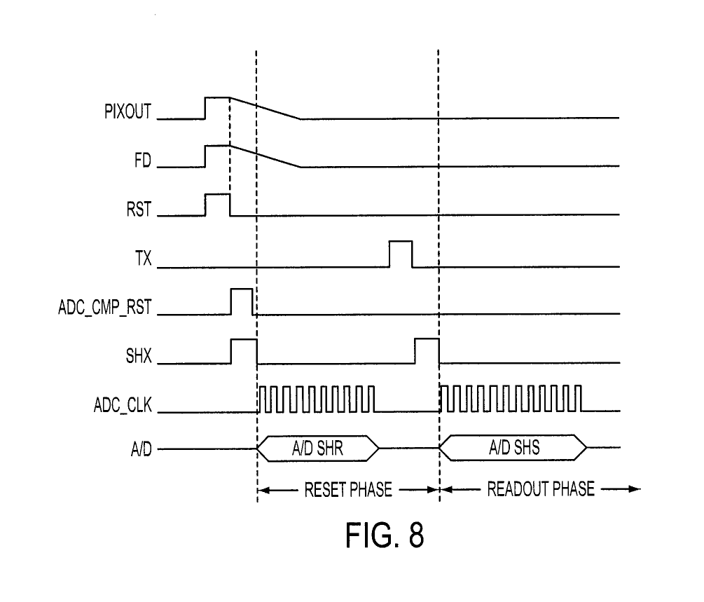

FIG. 8 shows how a strong light source discharges the pixel signal shortly after the RST control is released (at the falling edge of the RST control). This leads to a reduced pixel swing when the pixel signal is sampled. No anti-eclipse circuit is used in the signal relationships shown in FIG. 8.

Turning next to FIG. 9, there is shown an example of an anti-eclipse (AE) method, which is implemented using the previously described circuits. When executing DCDS, the reset level is sampled (SHR) and A/D converted first and, then the pixel signal is sampled (SHS) and A/D converted next. During reset sampling, the ADC's comparator is reset with pixout as the common mode voltage (ADC_CMP_RST), as illustrated. Thus, the ADC remembers the first sampled reset level as its new zero value.

In the case of an eclipse, the pixel keeps discharging, while the ADC converts the reset level (SHR). After the reset conversion (SHR), the ADC samples the pixout level again (shown as AE), and compares it, in one clock cycle, to a digital threshold programmed into the ADC's DAC. The digital threshold is set so that some dark current into the pixel is allowed without triggering the comparator.

If the newly sampled reset level (AE) has dropped by more than the DAC's threshold level when compared to the level at which the ADC comparator was reset, eclipse is present and a bit at the output is set.

Next, the TX control is run and the signal level is converted (SHS). When the digital section 550 (FIG. 6A) processes the output data from the ADC, it will know that if the AE bit is set for a pixel, the pixel is saturated and the pixel level should be all at the 1 level, no matter what the signal and reset values are.

Referring now to FIG. 10, there is shown an example of a timing relationship with AE sampling (as shown in FIG. 9) and added clamp control. If the incoming light is very intense (e.g. 10⁶ lux or more), it is possible that the pixel signal can drop from the reset voltage to a ground level between the release of RST and the falling edge of ADC_CMP_RST. If so, the ADC's reset level will be at the ground level and eclipse cannot be detected. To prevent this, a form of pixout clamp is maintained during the reset phase by the present invention, but only to keep pixout from dropping below the digital threshold. By releasing the clamp before the second reset sampling (the AE sampling), as shown in FIG. 10, eclipse can be detected for all light intensities.

The clamp level can be kept coarse, and unlike a conventional AE clamp, it does not require a large, programmable DAC. Several sensors already have a current clamp which keeps the VLN current per column constant during signal sampling. This current clamp transistor can be re-used by adjusting the gate voltage for the first reset sampling.

The methods shown in FIGS. 9 and 10 should be applied to column parallel sensors running in DCDS mode.

Since there is one more bit of information to be read per pixel, the column memory 546 will increase by one bit cell, typically from 12 bits to 13 bits.

The methods shown in FIGS. 9 and 10 can easily be used with per-column SAR ADCs, where the AE threshold can be programmed into the DACs before the second reset sampling. It can also be used in cyclic ADCs, where tuning the AE threshold may be done by tuning the reference voltage. It can be used in ramp ADCs, as well, reducing conversion time, by comparing only one voltage and not sweeping the reference ramp.

The methods described herein allow the comparator of the ADC to be reset towards the pixout reset voltage, letting the pixel discharge during the SHR sampling and then the pixout voltage may be compared to a digital threshold. The ADC comparator offset is cancelled and the first reset level becomes a new reference voltage.

Because the ADC checks whether the pixout voltage has drifted more than the digital threshold since the comparator reset, any variation in reference voltage or transistor threshold voltages across the array is cancelled. Furthermore, since the comparator threshold is set digitally in the SAR DAC, it is insensitive to global variations.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An imager comprising:
a column line connected to a pixel array for providing a pixel output signal, the pixel output signal sampled during reset and readout phases, and
an analog-to-digital converter (ADC), coupled to the column line, for sampling the pixel output signal and providing a digital output signal,
wherein the ADC is configured to sample the pixel output signal twice, during the reset phase, to detect eclipse in the pixel output signal.

2. The imager of claim 1 wherein the ADC includes
a comparator, sequentially operated by a reset control, for comparing a first pixel output voltage and a second pixel output voltage, respectively, during first and second periods of the reset phase, and
the comparator is configured to provide an output bit indicating detection of an eclipse, based on a difference between the first and second pixel output voltages.

3. The imager of claim 2 including
a clock for clocking operation of the ADC,
wherein the output bit is provided to a column memory in one clock cycle.

4. The imager of claim 2 wherein
the comparator is configured for reset by a feedback signal from an output side of the comparator, and
the first pixel output voltage is provided as a first threshold value to an input side of the comparator upon reset of the comparator.

5. The imager of claim 4 wherein
the comparator is configured to compare the second pixel output voltage to a second threshold value to detect the eclipse.

6. The imager of claim 5 wherein
the second threshold value is provided to the input side of the comparator as a predetermined threshold value, and
the comparator is configured to compare the second pixel output voltage to the predetermined threshold value and provide the output bit based upon the comparison.

7. The imager of claim 1 including
a processor, coupled to the ADC, for receiving the pixel output signal during both the reset phase and the readout phase, and
if a notification of the eclipse is received, the processor is configured to set the pixel output signal during the readout phase to a maximum value.

8. The imager of claim 1 including
a clamping circuit, coupled to the column line, for preventing the pixel output signal from dropping below a digital threshold during the reset phase.

9. The imager of claim 9 wherein
the clamping circuit is enabled during a first sampling period of the reset phase, and
the clamping circuit is disabled during a second sampling period of reset phase.

10. The imager of claim 1 wherein the ADC includes
a successive approximation register (SAR) ADC, a cyclic ADC or a ramp ADC.

11. An eclipse detector for an imager including reset and readout phases of operation, at each column line of a pixel array, the eclipse detector comprising:
an ADC, coupled to a column line, for converting (a) a first voltage on the column line, during the reset phase of operation, and (b) a second voltage on the column line, during the reset phase of operation, and
a comparator for determining a difference between the first and second voltages,
wherein if the difference is greater than a predetermined value, the ADC is configured to output an eclipse detection flag, and
a processor is configured to receive the eclipse detection flag and set a pixel output to a maximum value during the readout phase.

12. The eclipse detector of claim 11 wherein
the comparator includes first and second threshold levels, at an input side of the comparator, for sequentially comparing (a) the first voltage to the first threshold level and (b) the second voltage to the second threshold level, and
the second threshold level is determined by the converted first voltage.

13. The eclipse detector of claim 12 wherein
the comparator is reset by the converted first voltage.

14. The eclipse detector of claim 11 including
a clamping circuit, coupled to the column line, for preventing the first voltage on the column line from dropping below a clamp level during the reset phase of operation.

15. The eclipse detector of claim 14 wherein
the clamping circuit is enabled during conversion of the first voltage and disabled during conversion of the second voltage.

16. A method of detecting eclipse in a pixel array comprising the steps of:
first sampling a column line, during a first period of a reset phase of operation, to obtain a first voltage;
second sampling the column line, during a second period of the reset phase of operation to obtain a second voltage, wherein the second period is after the first period;
comparing the first and second voltages to determine a voltage difference between them;
detecting an eclipse, if the voltage difference is greater than a predetermined amount.

17. The method of claim 16 including the steps of:
after detecting the eclipse, setting an intensity level of a pixel to a maximum value, and
outputting the maximum value during a readout phase of operation.

18. The method of claim 17 including the steps of:
transferring charge on a floating diffusion layer of a pixel, and
subsequently, outputting the maximum value during the readout phase of operation.

19. The method of claim 16 wherein first and second sampling of the column line includes
resetting a floating diffusion layer of a pixel, and
subsequently, performing the first and second sampling of the pixel.

20. The method of claim 16 including the steps of:
clamping the column line, during the step of first sampling; and
disabling the clamping of the column line, prior to the step of second sampling.
